(19) United States
(12) Patent Application Publication
(10) Pub. No.: US 2011/0013916 A1
(43) Pub. Date: Jan. 20, 2011

(54) IMAGE FORMING APPARATUS, PROCESS UNIT CARTRIDGE, AND METHOD OF MANAGING REPLACEMENT LIFE OF PROCESS UNIT CARTRIDGE

(75) Inventor: Tetsuo Katoh, Kanagawa (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/834,168

(22) Filed: Jul. 12, 2010

Related U.S. Application Data
(60) Provisional application No. 61/226,868, filed on Jul. 20, 2009.

(51) Int. Cl. G03G 15/00

(52) U.S. Cl. 399/25

(57) ABSTRACT

An image forming apparatus includes: a process unit cartridge including an IC chip memory configured to store a set value table in which a set value as the replacement life of a process unit cartridge and a present value as the number of times of reuse are stored; a reader writer configured to read data from and write data in the IC chip memory; and a control unit configured to compare the set value and the present value readout from the IC chip memory and cause, when the present value exceeds the set value, a display unit to display indication that replacement is necessary.

### CROSS-REFERENCE TO RELATED APPLICATION

This application is based upon and claims the benefit of priority from the prior the U.S.A. Patent Application No. 61/226868, filed on Jul. 20, 2009, and the entire contents of which are incorporated herein by reference.

### FIELD

An embodiment of the present invention relates to a process unit cartridge, the life of which can be accurately managed, and an image forming apparatus including the process unit cartridge.

### BACKGROUND

An image forming apparatus such as a copying machine, a MFP (Multifunction Peripheral), or a printer includes a process unit for forming a developer image. In the process unit, consumables such as a developer, a photoconductive drum, and a cleaning blade are included in a process unit cartridge.

The consumables are replaced every time a predetermined number of images are formed. The process unit cartridge also has a life. The life of the process unit cartridge unit is usually longer than the life of the consumables.

Therefore, replacement work is performed according to a procedure explained below in a site of service. When the life of the consumables is over, a serviceperson carries the process unit cartridge from a setting place of the image forming apparatus back to a service center, replaces the consumables, and reuses the process unit cartridge in another image forming apparatus.

Therefore, a replacement period for the consumables can be managed by a number-of-sheets counter of the image forming apparatus. However, the life of the process unit cartridge cannot be managed.

To solve this problem, there is proposed a technique for setting a storage medium in a process unit cartridge and storing a use history of consumables in the storage medium to perform life management for the consumables.

### BRIEF DESCRIPTION OF THE DRAWINGS

FIG. 1 is a diagram of the configuration of an image forming apparatus;

FIG. 2 is a diagram of the configuration of a process unit cartridge;

FIG. 3 is a block diagram of the configuration of the image forming apparatus;

FIG. 4 is a block diagram of the configurations of a radio tag and a reader writer;

FIG. 5 is a diagram of the structure of a set value table stored by an IC chip memory; and

FIG. 6 is a flowchart for explaining the operation of the image forming apparatus.

### DETAILED DESCRIPTION

Throughout this description, the embodiments and examples shown should be considered as exemplars, rather than limitations on the apparatus and methods of the present invention.

An image forming apparatus, a process unit cartridge, and a method of managing a replacement life of the process unit cartridge according to an embodiment of the present invention are explained below with reference to the accompanying drawings. Examples of the image forming apparatus include a copying machine, a NFP (Multifunction Peripheral), and a printer.

An image forming apparatus 1 includes: a replaceable and reusable process unit cartridge configured to house at least one of an electrostatic latent image bearing member and a developer supplying unit configured to supply a developer to the electrostatic latent image bearing member; a storage medium arranged in the process unit cartridge and configured to store the number of times of reuse of at least the process unit cartridge; a reader writer configured to read out the number of times of reuse from the storage medium or record the number of times of reuse; and a display unit configured to display, when the number of times of reuse exceeds a predetermined value, indication that it is necessary to replace a process unit.

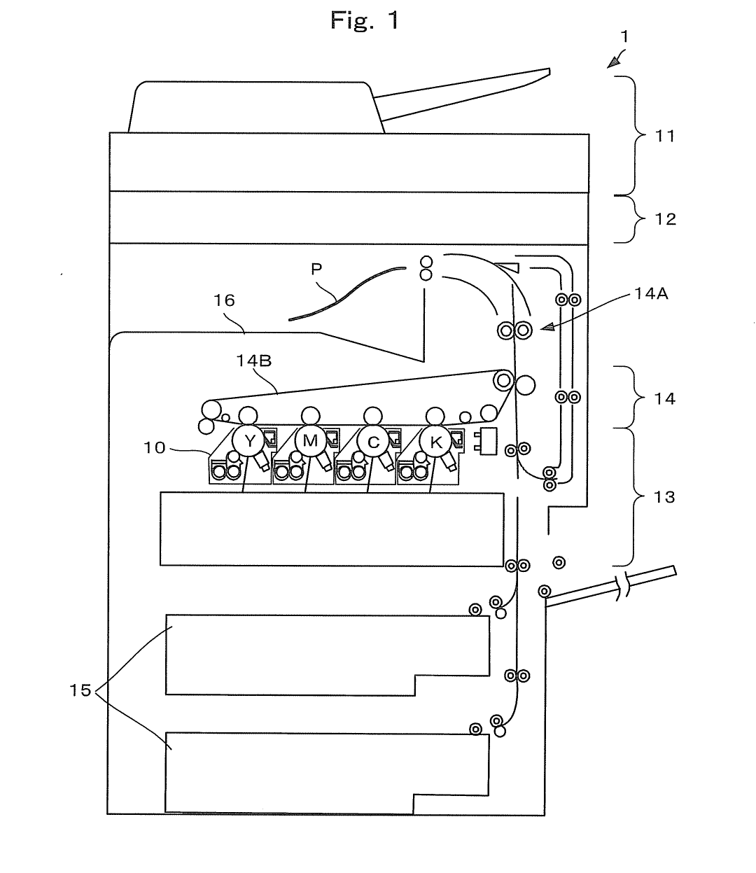

FIG. 1 is a diagram of the configuration of the image forming apparatus 1 according to this embodiment. As shown in FIG. 1, the image forming apparatus 1 includes an auto document feeder 11, an image reading unit 12, an image forming unit 13, a transfer unit 14, a sheet conveying mechanism, and a paper feeding unit 15.

The auto document feeder 11 is openably and closably set in an upper part of a main body of the image forming apparatus 1. The auto document feeder 11 includes a document conveying mechanism configured to extract original documents from a paper feeding tray one by one and convey the original document to a paper discharge tray.

The auto document feeder 11 conveys, with the document conveying mechanism, the original documents to an image reading section of the image reading unit 12 one by one. A user can open the auto document feeder 11 to place an original document on a document table of the image reading unit 12.

The image reading unit 12 includes a carriage including an exposure lamp configured to expose an original document to light and a first reflection mirror, plural second reflection mirrors set in a main body frame of the image forming apparatus 1, a lens block, and a CCD (Charge Coupled Device) of an image reading sensor.

The carriage stands still in the document reading section or reciprocatingly moves under the document table and causes the first reflection mirror to reflect the light of the exposure lamp reflected by the original document. The plural second reflection mirrors cause the lens block to reflect reflected light of the first reflection mirror. The lens block magnifies the reflected light and outputs the reflected light to the CCD. The CCD converts incident light into an electric signal and outputs the electric signal to the image forming unit 13 as an image signal.

The image forming unit 13 includes process unit cartridges 10 and laser irradiating units respectively for yellow Y, magenta M, cyan C, and black K.

Each of the process unit cartridges 10 includes a photoconductive drum as an electrostatic latent image bearing member, a developer supplying unit, and an IC chip memory as a storage medium.

The laser irradiating unit irradiates a laser beam on the photoconductive drum on the basis of the image signal and forms an electrostatic latent image on the photoconductive drum. The developer supplying unit supplies a developer to the photoconductive drum and forms a developer image from the electrostatic latent image.

The paper feeding unit 15 extracts sheets P from a paper feeding cassette one by one and passes the sheet P to the sheet conveying mechanism. The sheet conveying mechanism conveys the sheet P to the transfer unit 14.

The transfer unit 14 includes a transfer belt 14B, a transfer roller as a transfer device, and a fixing device 14A. The transfer belt 14B as an image bearing member receives transfer of the developer image on the photoconductive drum and bears the developer image. The transfer roller applies voltage or pressure to the developer image on the transfer belt 14B and transfers the developer image onto the sheet P conveyed thereto. The fixing device 14A heats and presses the developer image and fixes the developer image on the sheet P.

The sheet P discharged from a discharge port is stacked on a paper discharge tray 16.

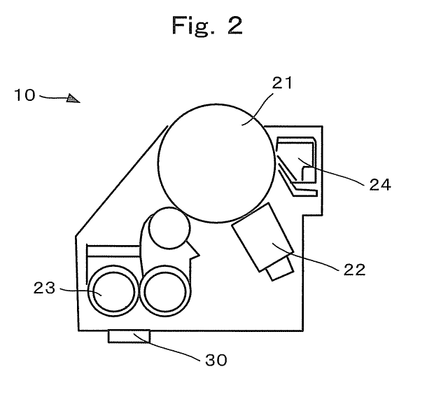

FIG. 2 is a diagram of the configuration of the process unit cartridge 10. As shown in FIG. 2, the process unit cartridge 10 detachably includes a photoconductive drum 21, a charging device 22 configured to apply voltage to the photoconductive drum 21, a developer supplying unit 23 configured to supply a developer to the photoconductive drum 21, a cleaning unit 24 configured to clean the photoconductive drum 21, and an IC chip memory 30 as a storage medium.

The process unit cartridge 10 is detachably set in the image forming apparatus 1. The process unit cartridge is replaceable and reusable. The process unit cartridge 10 may be formed as one cartridge or may be formed to be dividable into plural sections. When the process unit cartridge 10 is formed to be dividable into plural sections, the process unit cartridge 10 includes a section in which at least the photoconductive drum 21 is housed and a section in which at least the developer supply unit 23 is housed.

When the process unit cartridge 10 is formed to be dividable into plural sections, the process unit cartridge 10 includes the IC chip memory 30 in each of the divided sections.

The IC chip memory 30 as the storage medium may be a contact-type memory or a radio tag, i.e., an REID. The IC chip memory 30 includes a nonvolatile memory. The radio tag is explained below as an example of the IC chip memory 30.

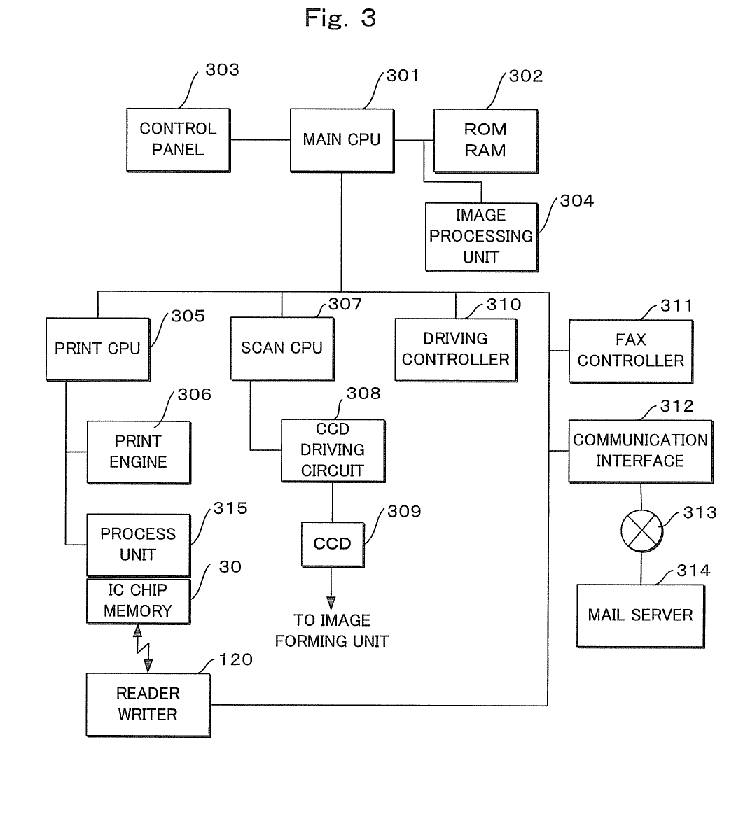

FIG. 3 is a block diagram of the configuration of the image forming apparatus 1. As shown in FIG. 3, the image forming apparatus 1 includes a main CPU 301 as a control unit, a control panel 303 as a display device or an input and output device, a ROM and RAM 302 as a storage device used by the main CPU 301, and an image processing unit 304 configured to perform image processing.

The main CPU 301 is connected to a print CPU 305 configured to control units of an image forming system, a scan CPU 307 configured to control units of an image reading system, and a driving controller 310 configured to control a driving unit.

The print CPU 305 controls a print engine 306 configured to form an electrostatic latent image on the photoconductive drum 21 and a process unit 315 configured to form a developer image.

The scan CPU 307 controls a CCD driving circuit 308 configured to drive a CCD 309. A signal from the CCD 309 is output to the image forming unit 13.

The process unit 315 is housed in the process unit cartridge 10. The process unit cartridge 10 includes the IC chip memory 30.

The main CPU 301 includes a facsimile controller 311 configured to transmit and receive facsimile, a communication interface 312 such as a LAN interface, and a reader writer 120 configured to read data from and write data in the radio tag as the IC chip 30.

The facsimile controller 311 is connected to a telephone line. The communication interface 312 is connected to a mail server 314 configured to transmit and receive electronic mail via a public communication line network 313 such as the Internet.

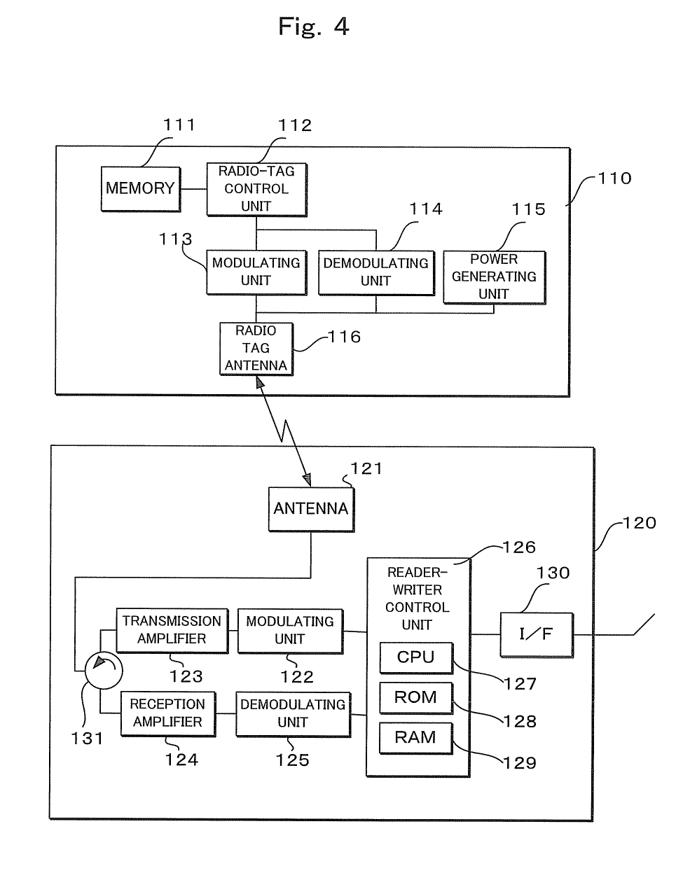

FIG. 4 is a block diagram of the configurations of a radio tag 110 and the reader writer 120. As shown in FIG. 4, the radio tag 110 includes a memory 111 as a storage device, a radio-tag control unit 112 configured to read data from and write data in the memory 111, a power generating unit 115 configured to perform rectification and stabilization of a received modulated electromagnetic wave to thereby supply electric power, a radio tag antenna 116 as an antenna for transmitting and receiving a signal, a modulating unit 113 configured to modulate data sent from the radio-tag control unit 112 and send the data to the radio tag antenna 116, and a demodulating unit 114 configured to demodulate the received modulated electromagnetic wave and sends the demodulated electromagnetic wave to the radio-tag control unit 112.

The reader writer 120 includes a reader-writer control unit 126 configured to control communication with the radio tag 110 and control respective kinds of hardware connected to the reader writer 120, a modulating unit 122 configured to modulate a signal sent from the reader-writer control unit 126, a transmission amplifier 123 configured to amplify the modulated signal and sends the modulated signal to an antenna 121 via a circulator 131, a reception amplifier 124 configured to amplify a modulated electromagnetic wave received from the antenna 121 via the circulator 131, a demodulating unit 125 configured to demodulate a received modulated signal, and an interface 130 connected to a host apparatus such as a personal computer and perform exchange of data. The reader-writer control unit 126 includes a CPU 127 and a ROM 128 and a RAM 129 as memories configured to store data.

A reader writer used in a service center has a configuration same as the configuration of the reader writer 120.

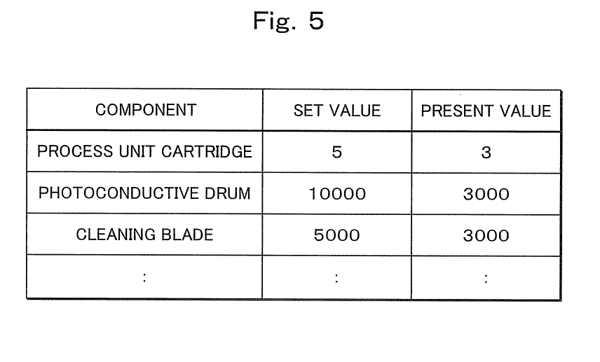

FIG. 5 is a diagram of the structure of a set value table stored by the IC chip memory 30. As shown in FIG. 5, the set value table stores “component” indicating a component name, “set value” as the replacement life of a component, and “present value” indicating the present number of times the component is reused, i.e., the present number of times of replacement or the number of sheets on which images are formed.

As examples of data stored in the set value table, the “component” is “process unit cartridge” and “photoconductive drum”, “cleaning blade”, and the like as consumables included in the process unit cartridge 10, the “set value” is “5” and the like, and the “present value” is “3” and the like.

When the process unit cartridge 10 is replaced, the present value is read out from the radio tag 110 by using the reader writer in the service center. If the present value is the same as the set value, the process unit cartridge 10 is not reused.

After the consumables of the process unit cartridge 10 are replaced, a number obtained by adding 1 to the set value by using the reader writer is written in the present value of the set value table of the radio tag 110.

The image forming apparatus 1 reads out, using the reader wrier 120, the present value every time images are formed on one thousand sheets. The image forming apparatus 1 writes a number obtained by adding 1000 to the read-out present value in the present value of the set value table of the radio tag 110.

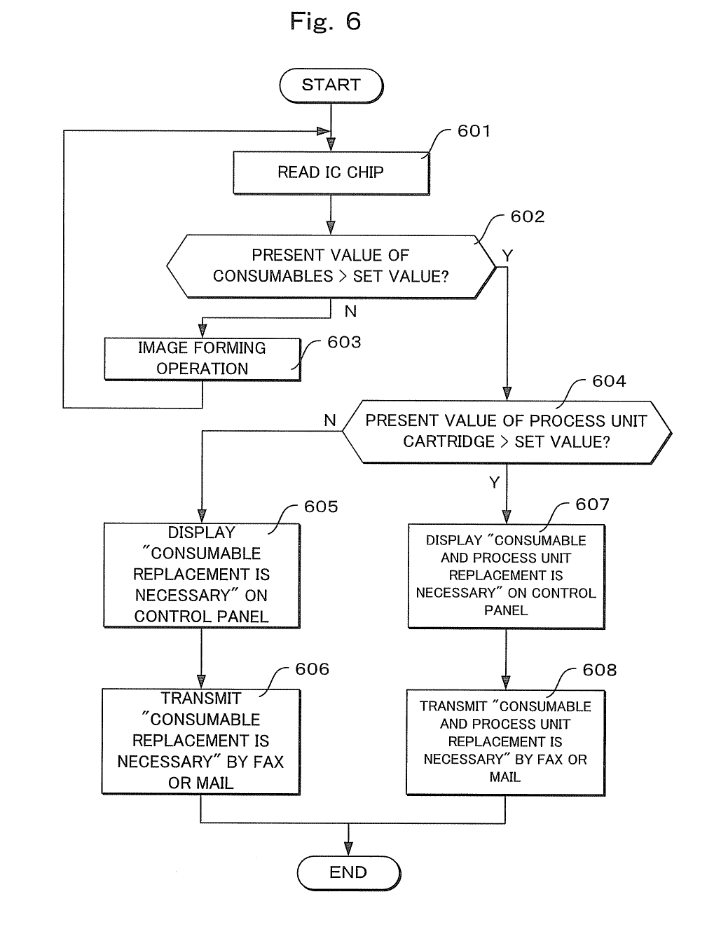

FIG. 6 is a flowchart for explaining the operation of the image forming apparatus 1. As shown in FIG. 6, in Act 601, the image forming apparatus 1 reads out, using the reader writer 120, the set value and the present value of each of the process unit cartridge 10 and the consumables stored in the set value table of the IC chip 30.

In Act 602, the image forming apparatus 1 determines whether the present values of the consumables exceed the set values thereof. If the present values of the consumables exceed the set values, the image forming apparatus 1 proceeds to Act 604. If the present values do not exceed the set values, the image forming apparatus 1 proceeds to Act 603.

In Act 603, the image forming apparatus 1 performs image formation and returns to Act 601. In Act 604, the image forming apparatus 1 determines whether the present value of the process unit cartridge 10 exceeds the set value. If the present value of the process unit cartridge 10 exceeds the set value, the image forming apparatus 1 proceeds to Act 607. If the present value does not exceed the set value, the image forming apparatus 1 proceeds to Act 605.

In Act 605, the image forming apparatus 1 displays, on a display unit of the control panel 303, indication that replacement of the consumables is necessary. In Act 606, the image forming apparatus 1 transmits information indicating that replacement of the consumables is necessary to the service center by facsimile or electronic mail via the mail server 314.

In Act 607, the image forming apparatus 1 displays, on the display unit of the control panel 303, indication that replacement of the process unit cartridge 10 and the consumables is necessary. In Act 608, the image forming apparatus 1 transmits information indicating that replacement of the process unit cartridge 10 and the consumables is necessary to the service center by facsimile or electronic mail via the mail server 314.

As explained above, the process unit cartridge 10 according to this embodiment includes the IC chip memory 30 configured to store the set value as the replacement life of the process unit cartridge 10 and the present value as the present number of times the process unit cartridge 10 is reused. The image forming apparatus 1 according to this embodiment includes the process unit cartridge 10 including the IC chip memory 30 configured to store the set value as the replacement life of the process unit cartridge 10 and the present value as the present number of times the process unit cartridge 10 is reused, the reader writer 120 configured to read data from and write data in the IC chip memory 30, and the control unit configured to compare the set value and the present value read out from the IC chip memory 30 and cause, when the present value exceeds the set value, the display unit to display indication that replacement of the process unit cartridge 10 is necessary.

Therefore, there is an effect that the process unit cartridge 10 that exhausts its replacement life is not used.

While certain embodiments have been described, these embodiments have been presented by way of example only, and are not intended to limit the scope of the inventions. Indeed, the novel methods and apparatuses described herein may be embodied in a variety of other forms; furthermore, various omissions, substitutions and changes in the form of the methods and systems described herein may be made without departing from the spirit of the inventions. The accompanying claims and their equivalents are indeed to cover such forms or modifications as would fall within the scope and spirit of the inventions.

1. An image forming apparatus comprising:
a replaceable and reusable process unit cartridge configured to house at least either an electrostatic latent image bearing member or a developer supplying unit configured to supply a developer to the electrostatic latent image bearing member;
a storage medium arranged in the process unit cartridge and configured to store a number of times of reuse of at least the process unit cartridge;
a reader configured to read out the number of times of reuse from the storage medium;
a writer configured to record the number of times of reuse; and
a display unit configured to display, when the number of times of reuse exceeds a predetermined value, indication that it is necessary to replace a process unit itself.

2. The apparatus according to claim 1, wherein the storage medium further stores a replacement life of the process unit cartridge and a replacement life of consumables.

3. The apparatus according to claim 1, wherein
the storage medium is a radio tag,
the reader is a radio tag reader, and
the writer is a radio tag writer.

4. The apparatus according to claim 1, wherein the storage medium is a contact-type IC chip memory.

5. The apparatus according to claim 1, wherein
the process unit cartridge is formed to be dividable into plural sections, and
each of the divided sections of the process unit cartridge has the storage medium.

6. The apparatus according to claim 1, wherein the control unit updates, when image formation is performed, with the reader and the writer, the number of times of reuse stored in the storage medium.

7. The apparatus according to claim 1, wherein the control unit reads out the replacement life and the number of times of reuse of the process unit cartridge from the storage medium and displays, when the number of times of reuse exceeds the replacement life, on the display unit, indication that the process unit cartridge should be replaced.

8. The apparatus according to claim 1, further comprising a facsimile controller configured to transmit facsimile, wherein
the control unit reads out the replacement life and the number of times of reuse of the process unit cartridge from the storage medium and causes, when the number of times of reuse exceeds the replacement life, the facsimile controller to transmit facsimile indicating that the process unit cartridge should be replaced.

9. The apparatus according to claim 1, further comprising a communication interface connectable to a public communication line network, wherein
the control unit reads out the replacement life and the number of times of reuse of the process unit cartridge from the storage medium and transmits, when the number of times of reuse exceeds the replacement life, via the communication interface, electronic mail indicating that the process unit cartridge should be replaced.

10. A replaceable and reusable process unit cartridge of an image forming apparatus, comprising:
at least one of an electrostatic latent image bearing member configured to bear an electrostatic latent image and a developer supplying unit configured to supply a developer to the electrostatic latent image; and
a storage medium configured to store a number of times of reuse of at least the process unit cartridge.

11. The process unit cartridge according to claim 10, wherein the storage medium further stores a replacement life of the process unit cartridge and a replacement life of consumables.

12. The process unit cartridge according to claim 10, wherein the storage medium is a radio tag.

13. The process unit cartridge according to claim 10, wherein the storage medium is a contact-type IC chip memory.

14. The process unit cartridge according to claim 10, wherein
the process unit cartridge is formed to be dividable into plural sections, and
each of the divided sections of the process unit cartridge has the storage medium.

15. The process unit cartridge according to claim 10, wherein, when the image forming apparatus performs image formation with a control unit of the image forming apparatus, the number of times of reuse stored in the storage medium is updated by a reader writer of the image forming apparatus.

16. A method of managing a replacement life of a process unit cartridge of an image forming apparatus, the method comprising:
arranging, in a process unit cartridge configured to house at least one of an electrostatic latent image bearing member configured to bear an electrostatic latent image and a developer supplying unit configured to supply a developer to the electrostatic latent image, a storage medium configured to store a replacement life and a number of times of reuse of at least the process unit cartridge; and
a control unit reading out, with a reader configured to read data from the storage medium, the replacement life and the number of times of reuse of the process unit cartridge and displaying, when the number of times of reuse exceeds a predetermined value, indication that it is necessary to replace a process unit itself.

17. The method according to claim 16, further comprising the control unit writing, with a writer configured to write data, the number of times of reuse in the storage medium.

18. The method according to claim 16, further comprising the control unit causing, when determining that the number of times of reuse exceeds the replacement life, a facsimile controller to transmit facsimile indicating that the process unit cartridge should be replaced.

19. The method according to claim 16, further comprising the control unit transmitting, when determining that the number of times of reuse exceeds the replacement life, via a communication interface, electronic mail indicating that the process unit cartridge should be replaced.

20. The method according to claim 16, further comprising the control unit updating, when image formation is performed, the number of times of reuse with the reader and the writer of the image forming apparatus.
